(19) United States
(12) Patent Application Publication
(10) Pub. No.: US 2009/0204967 A1
(43) Pub. Date: Aug. 13, 2009

(54) Reporting of information pertaining to queuing of requests

(75) Inventors: Kelsey L. Bruso, Minneapolis, MN (US); James M. Plasek, Shoreview, MN (US); Matthew E. Trautman, Minneapolis, MN (US)

Correspondence Address: UNISYS CORPORATION, Unisys Way, Mail Station E8-114, Blue Bell, PA, 19424, US

(73) Assignee: Unisys Corporation

(21) Appl. No.: 12/069,309

(22) Filed: Feb. 8, 2008

(51) Int. Cl. G06F 9/46

(52) U.S. Cl. 718/100

(57) ABSTRACT

Various approaches for capturing context data in a data processing arrangement are described. In one approach, a method controls shared access to an object for a plurality of requestors. An access control routine receives an access control request from a first routine of one of the requestors. The access control request specifies a type of control over access to the object and specifies a role descriptor that describes a processing context in the first routine of the requested access control to the object. The context is not visible to the access control routine without the role descriptor. The method determines whether the type of control can or cannot be immediately granted to the requestor. If the type of control cannot be immediately granted to the one of the requestors, the specified type of requested control and role descriptor are stored by the access control routine.

### FIELD OF THE INVENTION

The present invention generally relates to multi-host database management systems.

### BACKGROUND

Many software applications involve multiple requestors seeking access to a shared resource. For example, an airline reservation system concurrently processes reservation requests on behalf of the travelers seeking to travel the routes serviced by the airline. Database management system (DBMS) software underlies the application software and controls access to the shared data resources in order to maintain database consistency. For other types of applications, underlying system software similarly controls access to data objects that are shared by multiple requestors.

System performance may be improved in multi-requestor applications by supporting concurrent processing of multiple requests. The system protects against data inconsistency by allowing only one requestor at a time to change the data of a particular object. This control may be implemented by way of lock control structures, timestamps, or semaphores, for example. The system also detects deadlock situations and suitably undoes any partially completed requests.

In supporting concurrent processing of requests while maintaining data consistency, the protection mechanisms may negatively impact system performance. Specifically, there may be a number of requests queued and waiting for access to the same data object. However, in some instances if the system is suitably configured the queuing may be reduced and the reduction in performance may be alleviated.

Systems sometimes display or log the unique identifier of the object for which multiple requestors request access at the time of the queuing or deadlock event. For example, the page number or record number within a file may be displayed or logged. The administrator may use this information and attempt to deduce why there were more than a desired number of requestors that were queued or why the deadlock occurred. This task may be difficult and error prone because by the time that the system is analyzed, the state of the system may have changed beyond that which the object identifier would be useful to determine potential causes of the undesirable behavior.

A method and system that address these and other related issues are therefore desirable.

### SUMMARY

The various embodiments of the invention provide methods and systems for capturing context data. In one embodiment, a method is provided. The method includes controlling with an access control routine, shared access to an object by a plurality of requesters. An access control request is input from a first routine of one of the requesters to the access control routine. The access control request specifies a type of control over access to the object and specifies a role descriptor that describes a processing context in the first routine of the requested access control to the object. The context is not visible to the access control routine without the role descriptor. The method determines whether the type of control can or cannot be immediately granted to one of the requesters. In response to determining that the type of control cannot be immediately granted to the one of the requesters, the specified type of requested control and role descriptor are stored by the access control routine.

In another embodiment, an apparatus is provided for capturing diagnostic information. The apparatus comprises means for managing shared access to an object by a plurality of requestors with an access control routine. Another means is provided for receiving an access control request from a first routine of one of the requesters to the access control routine. The access control request specifies a type of control over access to the object and specifies a role descriptor that describes a processing context in the first routine of the requested access control to the object, and the context is not visible to the access control routine without the role descriptor. The apparatus includes further means for evaluating whether the type of control can or cannot be immediately granted to one of the requestors. Means, responsive to finding that the type of control cannot be immediately granted to the one of the requestors, are provided for storing the specified type of requested control and role descriptor by the access control routine.

A data processing system is provided in another embodiment. The data processing system includes a processor arrangement, a memory coupled to the processor arrangement, and a persistent storage arrangement coupled to the memory and processor arrangement. The memory is configured with instructions executable by the processor arrangement for capturing context data. The persistent storage arrangement stores an object to which access is shared by a plurality of requestors. The processor arrangement in executing the instructions, controls access to the object with an access control routine. The access control routine receives from one of the plurality of requestors an access control request. The access control request specifies one of a read lock or an update lock on the object and specifies a role descriptor that describes a processing context in the requestor of the requested access control to the object. The context is not visible to the access control routine without the role descriptor. The access control routine determines whether the type of control can or cannot be immediately granted to one of the requesters. If the type of control cannot be immediately granted to the one of the requestors, the access control routine stores the specified type of requested control and role descriptor.

The above summary of the present invention is not intended to describe each disclosed embodiment of the present invention. The figures and detailed description that follow provide additional example embodiments and aspects of the present invention.

### BRIEF DESCRIPTION OF THE DRAWINGS

Other aspects and advantages of the invention will become apparent upon review of the Detailed Description and upon reference to the drawings in which:

FIG. 1 is a block diagram of an example data processing system in which various embodiments of the invention may be implemented;

FIG. 2 is an example of a B+tree structure that may be used to represent a database table;

FIG. 3 is a block diagram that illustrates functional components and data structures involved in locking of an object in accordance with an example embodiment of the invention;

FIG. 4 is a flowchart of an example process performed by a routine seeking control of access to a shared object; and

FIG. 5 is a flowchart of an example process performed by an access control routine in granting, denying, and queuing access control to a shared object in accordance with an embodiment of the invention.

### DETAILED DESCRIPTION

The various embodiments of the invention are described in terms of a database management system (DBMS) and the objects it locks in providing concurrent access to a shared database. Describing the embodiments with reference to a DBMS is for purposes of convenience and concreteness. Those skilled in the art will recognize, however, that the teachings herein may be applied to any granularity of database lock request (record, page, file, or other lockable structure) as well as to any system that has a lock and queue mechanism, for example, a test-and-set mechanism in an operating system. The embodiments of the invention could also be used to identify the reason a given service is being called in a Service-oriented Architecture (SOA). The embodiments of the invention are generally applicable to common software methods, subroutines, functions, procedures, services, etc. which are called by various other pieces of software to perform some form of operation.

An excess amount of queuing for control over an object may substantially decrease system performance. For some applications the queuing may be reduced by way of properly configuring the system. However, in order to properly configure the system it must first be determined what the system was doing at the time of the excess queuing. Whereas the parameters, objects, etc. passed to the routine that provides access control to an object typically only describe the access control or access that is sought, the embodiments of the present invention provide to the control routine additional information that describes that which the requestor is attempting to accomplish with the access control. The access control routine can then include this information in any diagnostic information it displays or records, or pass it on to general software it calls.

In a DBMS implementation, the requestor seeking the control over the object provides to an access control routine a role descriptor that describes why the requester is seeking the control. For example, the requestor may inform the access control routine that the object on which a lock is sought is the right-most data page, an interior index page (neither the left-most nor right-most index page), the root page, or a B+tree control page. Without the requester providing this role information, the access control routine would not have visibility of the relevance of the referenced object in the database. For a DBMS implementation the requestor may also indicate the operation for which control over the object is sought, for example, indicating that control is sought for purposes of performing a page split, a page merge or other database operation.

In the event that the access control request is queued, for example, because another requestor currently possesses a conflicting lock on the object, the access control routine stores the role descriptor. The information in the role descriptor may be used by a database administrator to determine whether changing any operating parameters or procedures would improve performance. For example, from one or more of the role descriptors the database administrator may determine that one of the following example actions would improve performance: a) allow dynamic preconditioning of the database in order to eliminate lock contention on the right-hand side of the B+tree (adding empty pages at the end for the database where sequential inserts are being performed); b) restructure the database table as a partitioned table; c) modify the physical attributes of the underlying file, for example, change the size of B+tree pages, move the file to a faster disk or divide (striping) the file across disks; d) eliminate non-critical yet contentious secondary indexes; and/or e) alter the database access pattern of the application program.

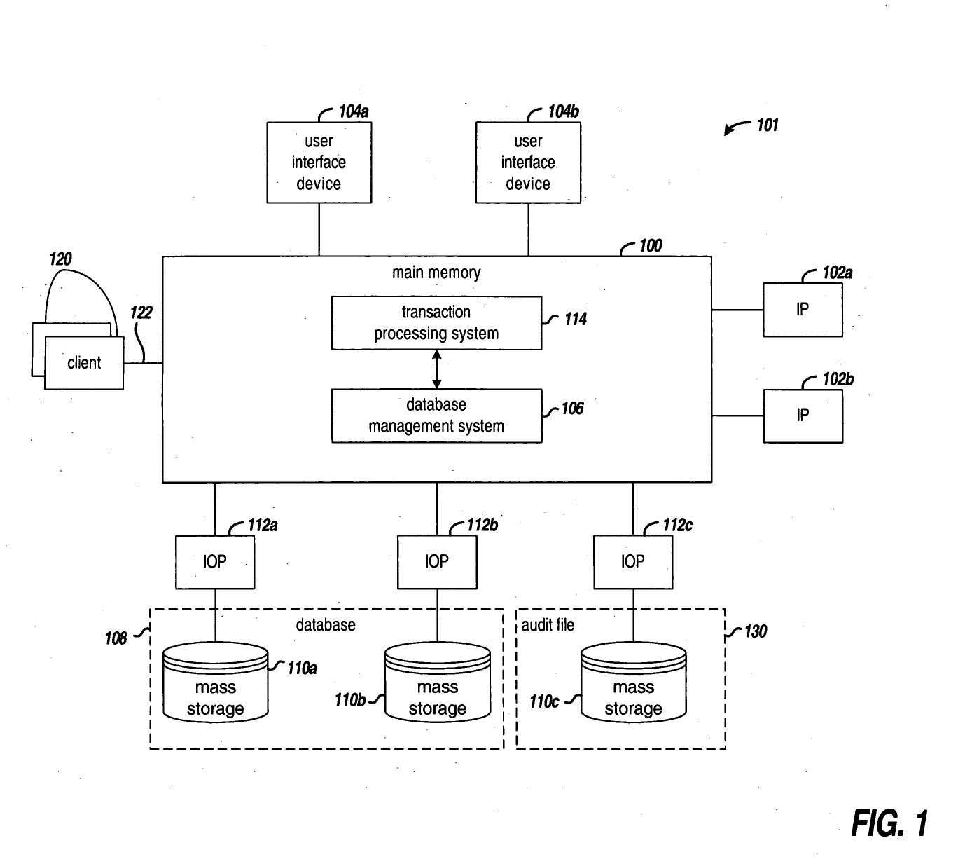

FIG. 1 is a block diagram of an example data processing system 101 in which various embodiments of the invention may be implemented. The example system illustrates a large-scale data processing system with multiple instruction processors (IPs) 102a and 102b. However, those skilled in the art will recognize that other types of data processing systems, such as a personal computer or a workstation may be used. The system includes a main memory 100 that is coupled to one or more IPs 102a and 102b. The memory may also be directly or indirectly coupled to one or more user interface devices 104a and 104b, which may include dumb terminals, personal computers, workstations, sound or touch activated devices, cursor control devices such as mice, printers, or any other known device used to provide data to, or receive data from, the data processing system.

A DBMS 106 is resident in main memory 100 and executes on IPs 102a and 102b to manage and provide access to a database 108 (shown dashed). The database may be stored on an arrangement of one or more mass storage devices 110a and 110b (or “persistent storage”). Mass storage devices may be hard disks or any other suitable type of non-volatile or semi non-volatile device. These mass storage devices may be configured as a Redundant Array of Independent Disks (RAID). As known in the art, this configuration provides a mechanism for redundantly storing multiple copies of the same data on multiple hard disks to improve efficient retrieval of the data, and to increase fault tolerance. Battery back up may be provided, if desired. The transfer of data between mass storage devices and DBMS is performed by Input/Output Processors (IOPs) 112a and 112b.

A transaction processing system 114 may be coupled to DBMS 106. The transaction processing system receives queries for data stored within database 108 from one or more users. Transaction processing system 114 formats the queries and then passes them to DBMS 106 for processing. DBMS 106 processes the queries by retrieving data records from and storing data records to the database 108.

The system of FIG. 1 may further support a client/server environment. In this case, one or more clients 120 are coupled to data processing system 101 via a network 122, which may be the Internet, an intranet, a local area network (LAN), wide area network (WAN), or any other type of network known in the art. Some, or all, of the one or more clients 120 may be located remotely from data processing system.

For purposes of database recovery, the DBMS may log data to the audit file 130 (or “audit trail”). With each processed transaction, the DBMS may write to mass storage 110c data that describes updates to one or more pages of data of the database. If recovery of the database is required, the records in the audit file may be used to reconstruct the database.

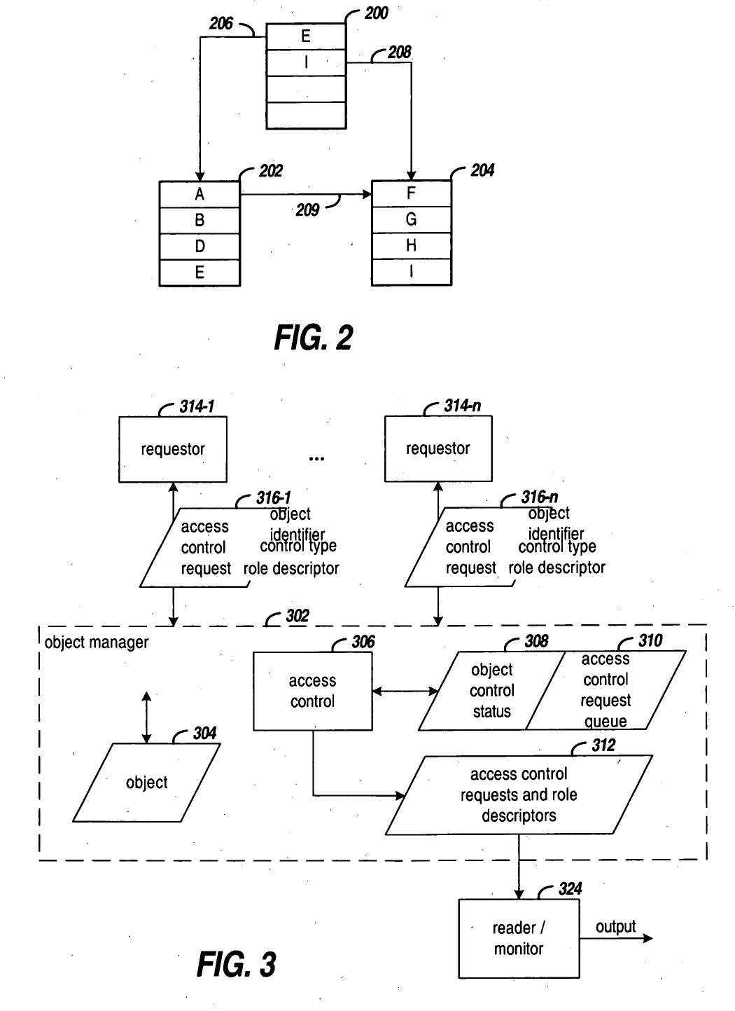

FIG. 2 is an example of a B+tree structure that may be used to represent a database table. The B+tree structure of FIG. 2 is presented for purposes of illustrating the several processing contexts from which the DBMS may request a lock on a page or record. Those skilled in the art will recognize that the invention is not so limited and is applicable to processing contexts other than DBMS locking of parts of a B+tree. In the illustrated B+tree structure only the leaf nodes contain data records and the leaf nodes are sequentially linked. In another embodiment, a B-tree may be employed wherein data records are stored in both the non-leaf and the leaf nodes.

The tree of FIG. 2 includes a non-leaf node 200 and two leaf nodes 202 and 204, which are children of non-leaf node 200. Generally, non-leaf nodes store index values and pointers identifying the child nodes. For example, non-leaf node 200 stores a pointer 206 and an index value “E” that identifies leaf node 202. Similarly, the non-leaf node stores a pointer 208.and an index value “I” identifying leaf node 204. Pointers 206 and 208 may each be an address, an offset, or any other type of indicia that uniquely identifies, and allows for efficient traversal to, a selected one of the leaf nodes. The index values specify the key of the last record stored in the referenced leaf nodes. For example, index “E” indicates that any records having index values between the first index value, “A”, and “E” will be located on leaf node 202, and any records having an index value after “E” but before, and including, “I” will be stored on leaf node 204. In another embodiment, non-leaf node 200 could store the index value for the first, rather than the last, record within the respective leaf node.

As discussed above, because the illustrated tree is a B+tree, the non-leaf nodes do not store the actual data records. Those records are only stored on the leaf nodes. For example, leaf node 202 stores records A-E. Similarly, leaf node 204 stores records F-I. These records are stored within the leaf in a sort order dictated by the index values “A”, “B”, “C”, and etc. These index values provide searchable data that are used to access a desired record. One or more index values may be used to arrange the records within a sort order. A primary and/or secondary key value may be used as an index value. As is known in the art, primary and secondary keys are searchable values identifying a record. In some embodiments, the primary key is used to uniquely identify a record. In other embodiments wherein each primary key value is not unique, some other mechanism such as a row identifier is used to uniquely identify each record.

In the tree of FIG. 2, leaf node 202 may store a pointer 209 to leaf node 204. This pointer may be an address or some other indicia that allows a sequential traversal of database records without traversing the index nodes of the tree. If desired, reverse pointers may be provided. For example, a pointer may be stored in leaf node 204 pointing to leaf node 202.

When non-leaf and leaf nodes are created, each of these nodes is allocated a predetermined amount of storage space by DBMS 106. The predetermined amount of storage space allocated to a node corresponds to a page of a file. The page size is usually based on the architectural characteristics of the underlying file system. For example, if the file system manages pages of 1792 bytes, the selected page size may be some multiple of 1792. A database administrator may select the size of the page, for instance. In one embodiment, the leaf nodes are the same size as the non-leaf nodes. In an alternative embodiment, the leaf nodes may be larger than the non-leaf nodes, or vice versa. In any event, DBMS 106 and any database application accessing the database are aware of the size of the leaf and non-leaf nodes.

The following scenario illustrates one example in which the objects maintained by the DBMS are locked in order to control concurrent access. In sequentially adding records to the database, records having key values A, B, D, E, F, G, H, and I are inserted in order. Note that the tree illustrates the state of the database after all the records have been added. Backing up to the time when record I is inserted, when the record having an index value of I is to be inserted in tree, root node 200 is searched to determine that the last record on node 204 has the index value I. Therefore, pointer 208 will be used to locate node 204, to store the new record. After searching the records of node 204, the insertion point for the new record is located after the record having an index value of H. Since node 204 has adequate space to accommodate this new record, the store operation is performed. During these update procedures, the pages corresponding to nodes 200 and 204 are locked to prevent two software transactions from attempting to update the same records at once. The locking of the pages corresponding to nodes 200 and 204 may be accomplished by activating an exclusive lock operation on those pages. This type of operation prohibits any other transaction from reading from or writing to these nodes until the insert transaction is committed, for example, by creating an audit trail of the transaction in the mass storage arrangement 108.

It may be noted that in some cases, the located leaf node will not have enough space to store a new record. For example, once record I is inserted node 204 will not have enough storage space available for a record J. In this situation, another leaf node must be created. This node is added to the tree by updating parent node 200 to include a pointer to the new leaf node. Additionally, pointers are updated and/or created at the leaf-node level to link the new node to one or more adjacent leaf nodes. For example, if a new leaf node is inserted between nodes 202 and 204, pointer 209 is updated to point to this new node. A pointer is also created within the new leaf node to point to leaf node 204. In this type of situation, all nodes associated with these operations must be locked during the update operation. For example, if node 202 is being updated to include a pointer to a newly created leaf node, the page corresponding to node 202 must be locked during the update and creation of the audit trail entry.

In the scenario described above, appending a sequence of records to a database can be particularly time consuming because concurrency is limited by the sequence of updates to the index page (e.g., 200).

To address the problems associated with storing a sequence of records to a database, some DBMSs utilize record-level locking during audit trail creation. Returning to the foregoing illustration, these systems lock only the records within nodes 200 and 204 that are being updated with the new index value and data, respectively, instead of locking an entire page corresponding to a node. This allows a concurrent request to store a record to the same leaf node that stores the previous record while the audit trail entry for that previous record is still under creation. However, this type of record-level locking substantially affects performance when system recovery must be performed after a failure occurs. This is because operations specified in each of the audit trail entries must be applied to a saved copy of the database in the correct sequence, one at a time. In contrast, when page-level locking is performed, an entire page may be recovered using a single copy operation.

FIG. 3 is a block diagram that illustrates functional components and data structures involved in access control of an object in accordance with an example embodiment of the invention. The object manager 302 manages access to the example target object 304 on which access control is sought. The object manager includes an access control component 306, which uses various data structures to manage the access control status of the object.

The object control status structure 308 is used to indicate the current control status of the object 304. The control status indicates whether a requestor has control over the object as well as the type of the control. If the object has a control status that does not permit access or control by a requestor other than the requestor currently possessing control, subsequent requests are stored in an access control request queue structure 310 by the access control component 306. Alternatively, if the requested control, for example, a lock, would create a deadlock then the request may be denied without queuing the request.

When the access control component 306 queues an access control request or denies the control request because of a potential for deadlock, the access control request and a role descriptor are stored in the data structure 312 by the access control component. The role descriptor describes the context in which the associated access control request was made. The context information describes the processing being performed by the requestor at the time the access control request was submitted and is unknown to the access control component without the requestor communicating it to the access control module. In one embodiment, structure 312 is implemented with a table that contains the access control requests and role descriptors for the x most recently queued access control requests, where x is chosen according to implementation requirements. Once the table 312 is full the access control routine 306 may preserve the current contents by ceasing to store subsequent access control requests and role descriptors for queued access control requests, until the administrator reads and clears the table. Alternatively, the access control routine may store subsequent access control requests and role descriptors by writing over the oldest entry in the table with each new request such that the table is logically circular. The table 312 may be stored in system memory (e.g., FIG. 1, 100) or retentively stored in persistent storage (e.g., 110a-c).

Requestors 314-1 and 314-n illustrate example components that make access control requests 316-1 and 316-n to the object manager 302 for control of object 304. According to one embodiment, each access control request includes data that specify: an object identifier of the object for which control is sought, a control type, and a role descriptor. The control type may vary according to the implementation. In a shared database implementation the control types may include a read lock and an update lock. When one requester has an update lock on an object, no other requester may obtain either an update lock or a read lock on the object. When one requester has a read lock on an object, no other requester may obtain an update lock, but other requesters may obtain read locks on that object.

The role descriptor describes the role the object plays in the action the caller is performing at the time of the access control request. For example, in a DBMS context, the following roles may be recognized:
the object is the right-most page of a B+tree during an insert;
the object is the end of a hash chain;
the object is an interior index page of a B+tree;
the object is the highest level index page involved in a page-merge;
the object is the root page of the B+tree; and
the object is a B+tree control structure.
   In an application context, the following roles may be recognized:
the object contains the running cash total for a branch bank;
the object is the key generator for message IDs;
the application is writing an order object to the order queue;
the application has run out of memory and is flushing a queued order object to a file;
the application is setting the order entry semaphore and waiting for the next order to process; and
the application is waiting for exclusive access to a file in order to back up that file.

The content and format of the role descriptor also depends on the implementation. For some implementations a simple status code may be used for indicating a known set of contexts. For other implementations, the role descriptor may include a textual description of the context.

In a particular example implementation each requestor 314-1 through 314-n corresponds to an in-process transaction of a DBMS. The DBMS generates the access control requests 316-1 through 316-n while processing the transactions. The role descriptors in the access control requests are status codes, each of which represents a processing condition of the DBMS. Table 1 below describes the role descriptor status codes passed by the DBMS in the access control requests. Each “Status code” is represented as a character string rather than a numerical value. The “Context description” describes the meaning of the status code as representing an operation being performed by the DBMS in issuing the access control request as queued by the access control. The “Administrator response” describes an action that may be taken by the database administrator in response to the status code.

TABLE 1

| Status Code | Context description | Administrator response |
|---|---|---|
| S‘right_pk_data’ | Seeking lock on right-most data | ALTER the table to make the primary |
| | page of primary key. This probably | key an IDENTITY column, or a |
| | means the user is appending | GENERATED expression. This will |
| | records to the table. | allow dynamic preconditioning. |
| S‘right_si_data’ | Seeking lock on right-most data | ALTER the table to make the leading |
| | page of secondary index. This may | index column a GENERATED |
| | mean that the user has created an | expression. This will allow dynamic |
| | index over a column that increases | preconditioning. |
| | with time (such as a date or | |
| | timestamp column). | |
| S‘root_pk’ | Seeking lock on the root page. This | If delete is involved, user should |
| S‘root_si’ | indicates that either the table is very | consider specifying the storage-area |
| | small or some run has caused a | attribute MERGE-FACTOR 0. Use of a |
| | page split or merge so drastic it has | GENERATED default may help if |
| | affected the b-tree's root page. | INSERT is involved because this will |
| | | allow dynamic preconditioning. If inserts |
| | | are random, but the table starts out too |
| | | small, static preconditioning may help. |
| | | Also, the use of partitioned tables may |
| | | help since there is a root page for each |
| | | partition. |
| S‘right_pk_index’ | Seeking lock on one of the right- | If the column is not a generated default, |
| S‘right_si_index’ | most index pages. This generally | making it a generated default may help. |
| | means that records are being | |
| | appended to the b-tree. Possibly, | |
| | the request is queued waiting for | |
| | another run to complete | |
| | preconditioning. | |
| S‘allocation_pg’ | Seeking an allocation page. DBMS | Partitioning the table will help because |
| | is doing a page split or a page | each partition has its own set of |
| | merge. There are likely many | allocation pages. |
| | concurrent inserts or deletes. | |
| S‘internal_pk_data’ | Seeking an internal level 0 page. | If the table is very small, evaluate the |
| S‘internal_si_data’ | This may happen during insert, | use of data-page-factor to 1 (one record |
| | update, or delete. | per data page) and merge-factor 0 (no |
| | | page merges). |
| S‘internal_pk_index’ | Seeking lock on an index page that | It is possible that the b-tree is too small. |
| S‘internal_si_index’ | is not the root page and is not at the | Use of static preconditioning, making |
| | right-hand side of the b-tree. This | the table partitioned, specifying merge- |
| | can happen with concurrent delete | factor 0, or using a generated default |
| | and insert runs. | may help. |

In some applications and scenarios as described above, the context of the requester as described by the role descriptor may be useful in changing operating parameters of the system in order to reduce the queuing of requests and increase throughput. Thus, the reader/monitor component 324 reads the requests and associated role descriptors for human or automated analysis.

The access control requests can be retrieved for display in error messages, logs, replays, or for display on real-time database monitors. The stored access control requests could also feed into tools that automatically tune database parameters. For example, knowing that deadlocks and/or excess queuing is occurring during page merge might indicate that the threshold parameter should be lowered for indicating when pages are to be merged during the delete of a record from one of those pages.

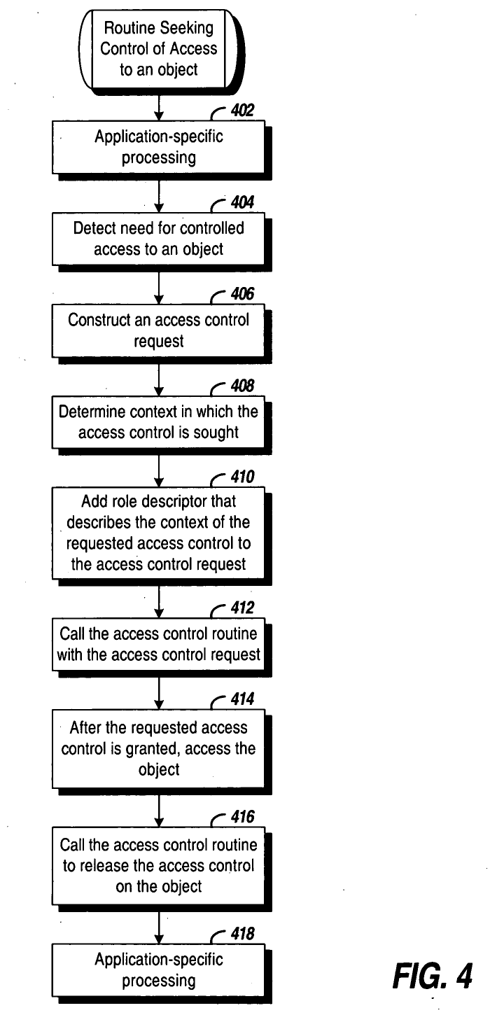

FIG. 4 is a flowchart of an example process performed by a routine seeking control of access to a shared object. Step 402 shows the routine performing application-specific processing, which will vary according to the application in which the embodiments of the invention are implemented. The routine detects the need for controlled access to an object at step 404. At step 406, the routine creates an access control request that describes the type of control that is sought (e.g., a type of lock).

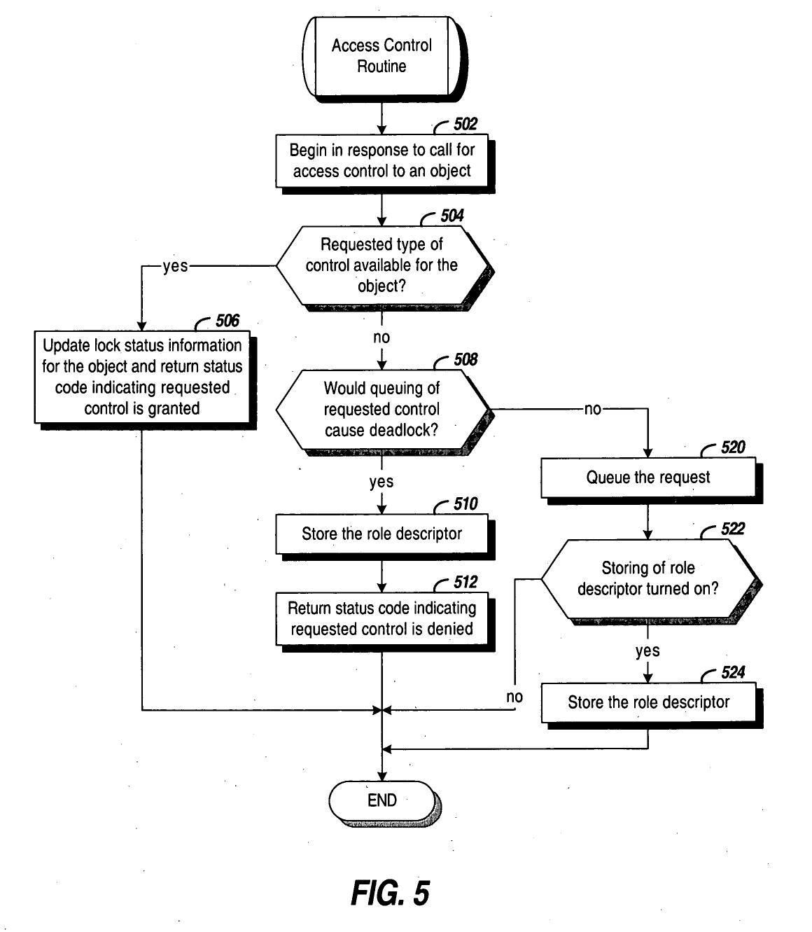

Based on the application-specific processing of step 402 and the detected need for controlled access at step 404, the routine also determines the context in which the access control is sought as shown by step 408. This context is added in the form of a role descriptor to the access control request at step 410. The routine seeking control of access to the object then calls an access control routine at step 412 with the access control request. Note that FIG. 5 shows an example process performed by an access control routine in processing control requests.

After the requested control is granted, the routine accesses the object at step 414. When access is complete, at step 416 the routine calls the access control routine to release the control held on the object. At step 418, the routine resumes its application-specific processing.

FIG. 5 is a flowchart of an example process performed by an access control routine in granting, denying, and queuing access control to a shared object in accordance with an embodiment of the invention. The routine commences processing at step 502 in response to a call or request received from a requestor for control of an object.

Decision step 504 determines whether the requested type of control is available for the specified object. If the requested control is available (e.g., the object is not locked), at step 506 the access control routine updates the lock status information maintained for the object and returns a status code to the requestor indicating that the control was granted.

If the requested control is not available, the access control routine proceeds to decision step 508 to determine whether queuing the control request would cause a deadlock. Known methods may be used to evaluate the currently queued requests and determine whether queuing the control request would cause deadlock. If deadlock would result, at step 510 the access control routine stores the information in the access control request, including the role descriptor, so that the context can be subsequently analyzed. The duration for which the access control request is stored depends on the implementation and may range from milliseconds, to hours, days, or weeks. The particular structure in which the access control request is stored also depends on implementation requirements. In a DBMS, for example, the access control request may be stored in memory or in a more permanent structure such as a B+tree or a log file. At step 512 a status code is returned to the requestor indicating that the requested control was denied.

If at step 508 the access control routine determines that queuing the request would not cause deadlock, at step 520 the access control request is queued. The storing of access control requests for subsequent analysis may be designed to be turned on/off dynamically for performance reasons. For example, the storing may be turned on for benchmarks or for other application tuning to see in-flight, transient queuing occurrences and turned off for normal production processing. In the example embodiment the access control request is always stored when deadlock is possible, but the storing can be dynamically turned on and off for tracking queuing reasons.

The access control routine determines at decision step 522 whether to store the role descriptor by checking a configuration flag, for example. If storing the role descriptor is turned on, the role descriptor is stored at step 524 and the process is complete. Otherwise, the role descriptor is not stored.

Those skilled in the art will recognize that the access control routine also processes access control requests that release the control over an object even though such processing is not illustrated in FIG. 5. The processing related to release of control is not affected by the embodiments of the invention described herein and is omitted for purposes of brevity.

Those skilled in the art will appreciate that various alternative computing arrangements, including one or more processors and a memory arrangement configured with program code, would be suitable for hosting the processes and data structures of the different embodiments of the present invention. In addition, the processes may be provided via a variety of computer-readable media or delivery channels such as magnetic or optical disks or tapes, electronic storage devices, or as application services over a network.

The present invention is thought to be applicable to a variety of software systems. Other aspects and embodiments of the present invention will be apparent to those skilled in the art from consideration of the specification and practice of the invention disclosed herein. It is intended that the specification and illustrated embodiments be considered as examples only, with a true scope and spirit of the invention being indicated by the following claims.

What is claimed is:

1. A processor-implemented method for capturing context data, comprising:
controlling with an access control routine, shared access to an object by a plurality of requesters; inputting an access control request from a first routine of one of the requestors to the access control routine, wherein the access control request specifies a type of control over access to the object and specifies a role descriptor that describes a processing context in the first routine of the requested access control to the object, wherein the context is not visible to the access control routine without the role descriptor; determining whether the type of control can or cannot be immediately granted to one of the requesters; and storing the specified type of requested control and role descriptor by the access control routine in response to determining that the type of control cannot be immediately granted to the one of the requestors.

2. The method of claim 1, further comprising queuing the access control request in response to determining that the type of control cannot be immediately granted to the one of the requestors.

3. The method of claim 1, further comprising reading and outputting the stored type of requested control and role descriptor.

4. The method of claim 2, further comprising:
determining whether or not queuing the access control request would cause deadlock; and in response to determining that queuing the access control request would cause deadlock, unconditionally storing the specified type of requested control and role descriptor and denying the queuing of the access control request; and in response to determining that queuing the access control request would not cause deadlock, queuing the access control request and storing the specified type of requested control and role descriptor.

5. The method of claim 4, wherein the storing of the specified type of requested control and role descriptor is conditional in response to a state of a configuration parameter.

6. The method of claim 1, wherein the type of control is one of a read lock and an update lock and the object is one of an index page and a data page of a B+tree

7. The method of claim 5, wherein the processing context is an insert to a right-most page of the B+tree.

8. The method of claim 5, wherein the processing context indicates requested control over an interior index page in the B+tree.

9. The method of claim 5, wherein the processing context indicates requested control over a root page of the B+tree.

10. The method of claim 1, wherein the storing comprises storing the specified type and role descriptor in a circular table.

11. An apparatus for capturing diagnostic information, comprising:
means for managing shared access to an object by a plurality of requestors with an access control routine; means for receiving an access control request from a first routine of one of the requesters to the access control routine, wherein the access control request specifies a type of control over access to the object and specifies a role descriptor that describes a processing context in the first routine of the requested access control to the object, wherein the context is not visible to the access control routine without the role descriptor; means for evaluating whether the type of control can or cannot be immediately granted to one of the requestors; and means, responsive to finding that the type of control cannot be immediately granted to the one of the requesters, for storing the specified type of requested control and role descriptor by the access control routine.

12. A data processing system, comprising: a processor arrangement; a memory coupled to the processor arrangement, the memory configured with instructions executable by the processor arrangement for capturing context data;a persistent storage arrangement coupled to the memory and to the processor arrangement for retentive storage of an object to which access is shared by a plurality of requesters;
wherein the processor arrangement in executing the instructions, controls access to the object with an access control routine; receives from one of the plurality of requestors an access control request, wherein the access control request specifies one of a read lock and an update lock on the object and specifies a role descriptor that describes a processing context in the requestor of the requested access control to the object, wherein the context is not visible to the access control routine without the role descriptor; determines whether the type of control can or cannot be immediately granted to one of the requesters; and stores the specified type of requested control and role descriptor by the access control routine in response to determining that the type of control cannot be immediately granted to the one of the requestors.

13. The system of claim 12, wherein the processor arrangement in executing the instructions further queues the access control request in response to determining that the type of control cannot be immediately granted to the one of the requestors.

14. The system of claim 12, wherein the processor arrangement in executing the instructions further reads and outputs the stored type of requested control and role descriptor.

15. The system of claim 13, wherein the processor arrangement in executing the instructions further: determines whether queuing the access control request would cause deadlock; and in response to determining that queuing the access control request would cause deadlock, unconditionally stores the specified type of requested control and role descriptor and denying the queuing of the access control request; and in response to determining that queuing the access control request would not cause deadlock, queues the access control request and stores the specified type of requested control and role descriptor.

16. The system of claim 15, wherein the storing of the specified type of requested control and role descriptor is conditional in response to a state of a configuration parameter and queuing of the access control request.

17. The system of claim 1, wherein the object is one of an index page and a data page of a B+tree.

18. The system of claim 16, wherein the processing context is an insert to a right-most page of the B+tree.

19. The system of claim 16, wherein the processing context indicates requested control over an interior index page in the B+tree.

20. The system of claim 16, wherein the processing context indicates requested control over a root page of the B+tree.
